(19) United States
(12) Patent Application Publication
(10) Pub. No.: US 2008/0083581 A1
(43) Pub. Date: Apr. 10, 2008

(54) COMPONENT OF EXHAUST SYSTEMS OF MOTOR VEHICLES WITH INTERNAL COMBUSTION ENGINES

(76) Inventors: Georg Reuther, Hochstadt (DE); Juergen Rickertsen, Lambrecht (DE)

Correspondence Address: MG-IP Law, PLLC, P.O. BOX 1364, FAIRFAX, VA, 22038-1364, US

(21) Appl. No.: 11/853,799

(22) Filed: Sep. 11, 2007

(30) Foreign Application Priority Data
Sep. 11, 2006 (DE) DE102006013873

(51) Int. Cl. F01N 7/10; B32B 15/04

(52) U.S. Cl. 181/227; 428/457

(57) ABSTRACT

An exhaust system of a motor vehicle with an internal combustion engine made of titanium or titanium alloys. In order to prevent undesirable discoloration or corrosion of the titanium surface, the surface is coated with an oxygen-tight inorganic nanocoating.

This nonprovisional application claims priority under 35 U.S.C. § 119(a) to German Patent Application No. DE 202006013873, which was filed in Germany on Sep. 11, 2006, and which is herein incorporated by reference.

### BACKGROUND OF THE INVENTION

1. Field of the Invention

The present invention relates to components for exhaust systems of motor vehicles with internal combustion engines, in particular manifolds, catalytic converters, mufflers and/or tailpipes subject to extreme thermal stresses, made of titanium or titanium alloys.

2. Description of the Background Art

Very high demands are placed on exhaust systems. To start with, they are subject to cyclic temperature stresses, since temperatures of up to 900° C. can occur near the motor in the region between the internal combustion engine and the catalytic converter, and also in and behind the catalytic converter.

In addition, bending and vibration stresses occur in the entire region of the exhaust system.

The most common cause of damage in exhaust systems is corrosion, which acts from both the inside and the outside. Wet corrosion, which can be exacerbated in winter because of salts or, depending on the climate and geographical influences, by acid components, causes the most damage. The effects of snow slush or melt water containing sodium chloride are intensified by the relatively high temperatures present at the outside of the exhaust system, even in winter.

On the inside of exhaust systems, wet corrosion primarily occurs in the rear, colder portion of the exhaust system as a result of excursions below the dew point, and is exacerbated by the acidic substances from the combustion process that are present in the condensate. The chemical and physical properties of the exhaust gas condensate, which forms and accumulates in the muffler in particular, are fundamentally different in diesel and gasoline engines. To begin with, the fuels differ in their chemical composition, particularly their sulfur content. In diesel engines the quantity of intake air is not throttled, in contrast to gasoline engines. Consequently, the dwell time of the exhaust gas in the exhaust system and its degree of cooling are less than in the gasoline engine. The dew point, at which the exhaust gas condensate forms, is typically lower for diesel engines than for gasoline engines, so that condensate is formed by diesel engines only in winter, if at all. In contrast, in gasoline engines condensate formation can even take place in the summer, since the dew point of the exhaust gas here is in the vicinity of 50° C.

The chemical properties of the exhaust gas condensate depend not only on the fuel composition, but also on the combustion process, the air-to-fuel ratio, the engine load, the exhaust gas temperature and the selectivity of the catalytic converter. In gasoline engines, the pH value of the exhaust gas condensate is in the alkaline range, which can also be traced to the formation of ammonia and ammonia compounds in the three-way catalytic converter. In contrast, the catalytic converters of diesel engines are extremely acidic. However, the sulfate concentration in the exhaust gas condensate of diesel engines is load-dependent, in contrast to gasoline engines, so that the composition and thus the physical and chemical properties of the condensate are different during cross-country trips and travel on highways than during city driving.

It is a matter of course that the manufacturers of exhaust systems endeavor to counteract susceptibility to corrosion by selecting suitable materials for housings and pipes. At present, the greatest success in this regard is obtained by selecting ferritic and, in particular, austenitic stainless steels with high alloy contents of chromium, nickel, silicon, manganese, and/or titanium. However, stainless steels are not only costly, but also heavy, i.e. they have a high specific weight. To minimize fuel consumption, however, all components of the exhaust system should have the lowest possible weight.

Attempts have thus already been made to use titanium in place of stainless steel in manufacturing exhaust systems. Titanium is significantly lighter than steel and has very good corrosion properties. However, aside from its high cost, titanium is only usable in exhaust systems to a limited extent. At high temperatures such as arise in the area near the engine, titanium takes up oxygen from the environment and becomes brittle and prone to breakage. This, however, is unsatisfactory.

### SUMMARY OF THE INVENTION

It is therefore an object of the present invention to improve exhaust system components made of titanium such that they can be used without problems even in the high-temperature area.

### DETAILED DESCRIPTION

According to an embodiment of the present invention, titanium surfaces are sealed, thus preventing the entry of oxygen. This effectively prevents embrittlement and susceptibility to breakage. Coating with an inorganic nanocoating has proven to be an optimal means for achieving this goal, since it does not increase weight, does not react with titanium, and above all does not degrade the surface appearance of titanium.

According to another embodiment of the invention, not only the outer surface but also the inner surface of a housing, in particular a muffler housing, is provided with a nanocoating resistant to exhaust gas condensate. In this way, the components of the exhaust system are effectively protected from embrittlement as well as from condensate attack.

According to one embodiment of the invention, the nanocoating is also impact resistant.

An additional advantage of the inventive nanocoatings are their insensitivity to temperature variations. Moreover, they can be deformed without cracking or breaking and are weldable.

It is a matter of course that the inventive nanocoatings can be applied not only in exhaust systems, but also in other systems that are exposed to comparable corrosive conditions.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A component for an exhaust system of a motor vehicle with an internal combustion engine, in particular manifolds, catalytic converters, mufflers and/or tailpipes, which are subject to extreme thermal stresses and are made of titanium or titanium alloys, wherein at least a portion of a surface of the component is provided with an oxygen-tight inorganic nanocoating.

2. The component according to claim 1, wherein an inner surface of a housing, in particular a muffler housing, is provided with a nanocoating that is resistant to exhaust gas condensate.

3. The component according to claim 1, wherein the surface is provided with an impact-resistant nanocoating.

4. A method of manufacturing an exhaust system for a motor vehicle, the method comprising:
providing a titanium component of the exhaust system; and
coating the titanium component with a nanocoating to thereby seal a surface of the titanium component to protect the titanium component from embrittlement and condensate, the nanocoating being substantially impact resistant and substantially insensitive to temperature variations.
